(19) United States
(12) Patent Application Publication
(10) Pub. No.: US 2008/0295642 A1
(43) Pub. Date: Dec. 4, 2008

(54) Pedal assembly

(76) Inventor: Chih-Ching Liou, Ta-Li City (TW)

Correspondence Address: CHARLES E. BAXLEY, ESQUIRE, 90 JOHN STREET, SUITE 309, NEW YORK, NY, 10038, US

(21) Appl. No.: 11/807,993

(22) Filed: May 30, 2007

(51) Int. Cl. G05G 1/14

(52) U.S. Cl. 74/594.5

(57) ABSTRACT

A pedal assembly includes an axle extending through the passage in the pedal and a nut is inserted into the passage from a first end of the pedal and threadedly connected to a threaded section of the axle. A bearing is mounted to the nut. Another bearing is inserted into the passage from a second end of the pedal and is mounted to the axle. A contact plate extends radially outward from an outer periphery of the axle and includes a friction surface. A crank has a threaded hole with which another threaded section of the axle is engaged. The friction surface includes multiple spikes so as to firmly contact the crank.

### FIELD OF THE INVENTION

The present invention relates to a pedal assembly wherein the axle includes a contact plate with a friction surface which is in contact with a side of the crank to securely combine the crank and the axle.

### BACKGROUND OF THE INVENTION

A conventional bicycle pedal assembly is shown in FIG. 1 and generally includes pedal 1 with a passage 10 defined therethrough and an axle 23 extends through the passage 10. The axle 23 includes a first threaded section 20 and a second threaded section 21 on two ends thereof. A nut 35 in inserted into an end of the passage 10 and includes a threaded hole 350 which is engaged with the second threaded section 21. Another bearing 11 is received in the other end of the passage 10 and the axle 23 extends through the bearing 11. The first threaded section 20 is threadedly connected with a threaded hole 30 of a crank 3. A contact plate 22 is located beside the first threaded section 20 and in contact with the crank 3. A weight 18 is connected to an underside of the pedal 1 so as to keep a top surface of the pedal 1 to face upward. However, the connection between the first threaded section 20 and the threaded hole 30 of the crank 3 is experienced to be easily loosened due to vibration when riding the bicycle on serrated roads.

The present invention intends to provide a pedal assembly wherein the axle includes a contact plate with has a friction surface which is in contact with the crank so as to increase the connection between the axle and the crank.

### SUMMARY OF THE INVENTION

The present invention relates to a combination of pedal assembly and crank, wherein the pedal has a passage through which an axle extends. The axle includes a first threaded section and a second threaded section on two opposite ends thereof. A nut is inserted into the passage from a first end of the pedal and a first bearing is mounted to the nut. The nut is threadedly connected to the second threaded section. A second bearing is inserted into the passage from a second end of the pedal and mounted to the axle. A contact plate extends radially outward from an outer periphery of the axle and includes a friction surface. A crank has a threaded hole with which the first threaded section is engaged. The friction surface contacts the crank.

The primary object of the present invention is to provide a pedal assembly wherein a contact plate extends radially outward from an outer periphery of the axle and includes a friction surface with a plurality of spikes which are firmly in contact with the crank so as to prevent the connection between the crank and the axle from loosening.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show a conventional pedal assembly connected with a crank;

FIG. 2 shows an axle of the pedal assembly of the present invention;

FIG. 3 is a cross sectional view to show that the axle of the pedal assembly is connected to the crank and the friction surface of the contact plate is not yet in contact with the crank, and

FIG. 4 is a cross sectional view to show that the axle of the pedal assembly is connected to the crank and the friction surface of the contact plate is in contact with the crank.

### DETAILED DESCRIPTION OF THE PREFERRED EMBODIMENT

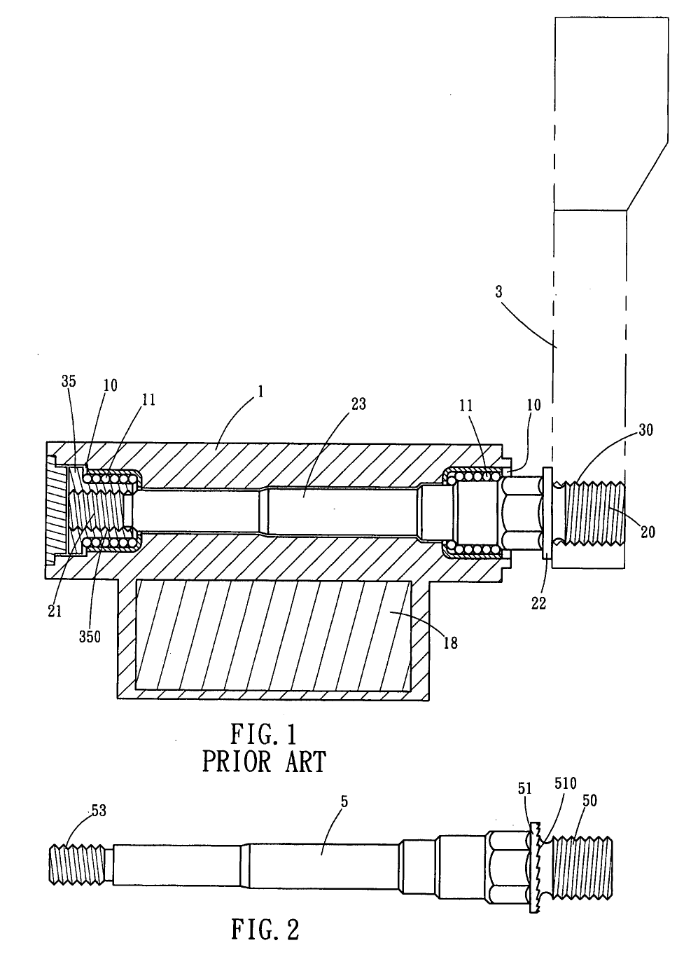

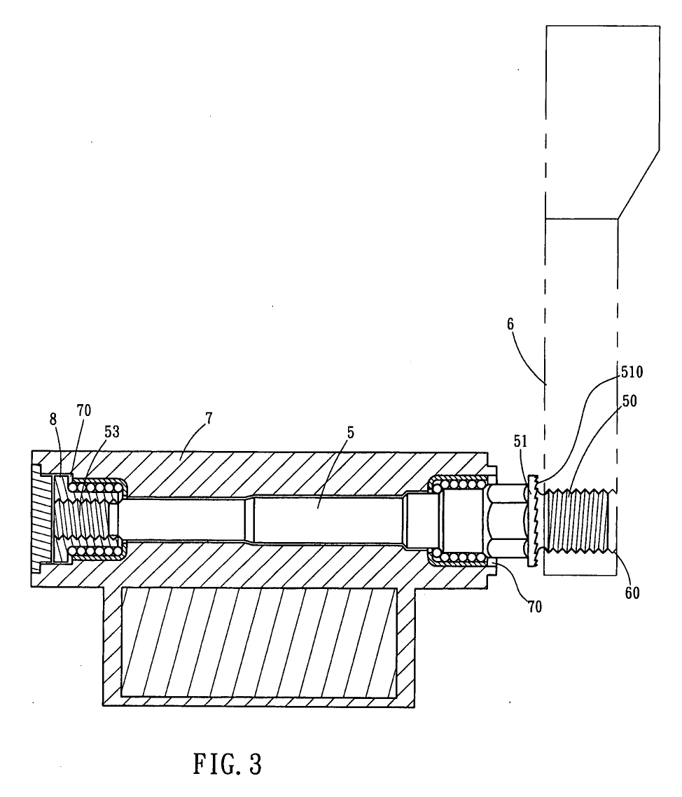

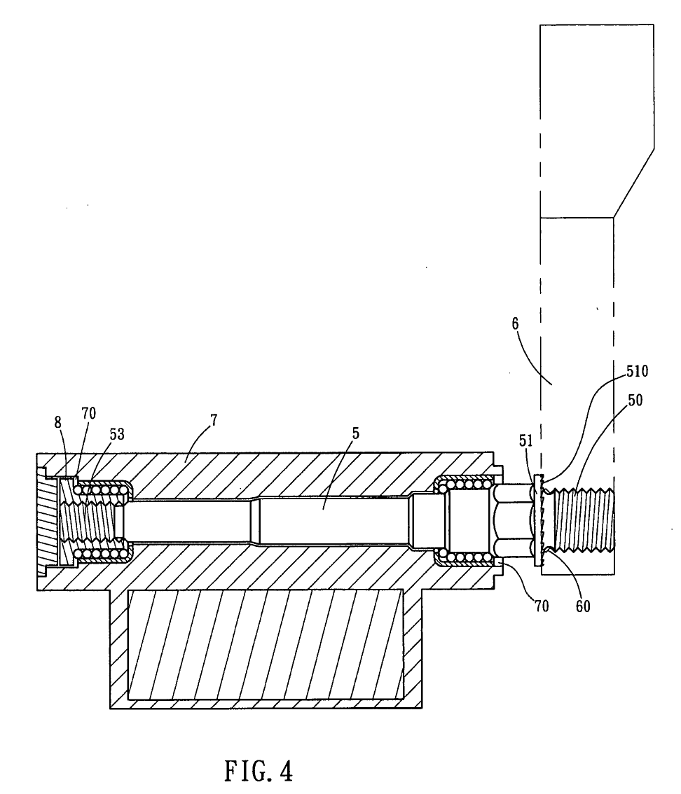

Referring to FIGS. 2 to 4, the pedal assembly of the present invention comprises a pedal 7 having a passage 70 defined therethrough and an axle 5 extends through the passage 70. The axle 5 includes a first threaded section 50 and a second threaded section 53 on two opposite ends thereof. A nut 8 is inserted into the passage 70 from a first end of the pedal 7 and a first bearing is mounted to the nut 8. The nut 8 is threadedly connected to the second threaded section 53.

A second bearing is inserted into the passage 70 from a second end of the pedal 7 and mounted to the axle 5. A contact plate 51 is connected to the axle 5 and extends radially outward from an outer periphery of the axle 5. The contact plate 51 includes a friction surface 510 which includes a plurality of spikes, bosses, or ridges extending therefrom.

A crank 6 has a threaded hole 60 with which the first threaded section 50 is engaged, the friction surface 510 contacting the crank 3. The friction surface 510 is firmly in contact with the crank 6. Preferably, the spikes of the friction surface 510 penetrate into the surface of the crank 6 to achieve the design purpose.

When the bicycle rides on a serrated road, the friction surface 510 ensures that the crank 6 is snuggly connect with the contact plate 51 so that the crank 6 is not loosened from the first threaded section 50 of the axle 5.

located at a the vibration does not separate
device for

While we have shown and described the embodiment in accordance with the present invention, it should be clear to those skilled in the art that further embodiments may be made without departing from the scope of the present invention.

What is claimed is:

1. A combination of pedal assembly and crank, comprising:
a pedal 7 having a passage 70 defined therethrough;
an axle 5 extending through the passage 70 and including a first threaded section 50 and a second threaded section 53 on two opposite ends thereof;
a nut 8 inserted into the passage 70 from a first end of the pedal 7 and a first bearing mounted to the nut 8, the nut 8 threadedly connected to the second threaded section 53, a second bearing inserted into the passage 70 from a second end of the pedal 7 and mounted to the axle 5, a contact plate 51 connected to the axle 5 and extending radially outward from an outer periphery of the axle 5, the contact plate 51 including a friction surface 510, and
a crank 6 having a threaded hole 60 with which the first threaded section 50 is engaged, the friction surface 510 contacting the crank 3.

2. The combination as claimed in claim 1, wherein the friction surface 510 includes a plurality of spikes extending therefrom.
